(19) United States
(12) Patent Application Publication
(10) Pub. No.: US 2003/0043036 A1
(43) Pub. Date: Mar. 6, 2003

(54) Loss prevention system for portable electronic devices

(75) Inventors: Ralph Merrem, San Francisco, CA (US); John Cavacuiti, Vancouver (CA)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Acco Brands, Inc.

(21) Appl. No.: 09/946,793

(22) Filed: Sep. 4, 2001

(51) Int. Cl. G08B 13/14

(52) U.S. Cl. 340/568.1; 340/686.6; 340/539

(57) ABSTRACT

A PDA protection system alerts a user of a PDA that the PDA is spaced apart from the user by distance exceeding a predetermined threshold. The PDA protection system contains a transmitting apparatus that provides a signal, and a receiving apparatus that receives the signal, to determine whether the PDA has been forgotten.

### BACKGROUND OF THE INVENTION

The present invention relates generally to security systems and methods for portable electronic devices, and more particularly to loss inhibition devices that help to prevent accidental loss of personal digital assistants.

PDAs (Personal Digital Assistants) are handheld computing devices that serve as personal organizers or communication devices, such as for example Pilot by Palm, Visor by Handspring and Blackberry by RIM. Many PDAs typically include a date book, address book, task list, and memo pad, as well as other features. Many are easily synchronized with a desktop computer, and may even be used to surf the World Wide Web. Many of these features are much easier to use than their non-electronic counterparts: for example, contacts may be searched in many different ways, and an appointment in a calendar may be linked with an email from someone about the appointment, and with a web-based map showing directions to a meeting site.

Many frequent travelers use PDAs to keep a track of expense details in real-time, to manage billing and expenses and to produce a comprehensive summary of expenses when they return to their offices. The portability of these devices makes them ideal for recording time spent on different matters at the time they are incurred, particularly when away from the office. Ancillary software packages are available that allow this information to be imported directly into financial, billing, or accounting software to ensure proper accounting and eliminate transcription errors.

PDAs also make an ideal repository for large amounts of reference material and other information in a small device, either stored locally within the PDA or remotely via the wireless ISP. Also, many software companies produce versions of their most common software that will run on a PDA platform. The ability to synchronize with desktop scheduling software allows professionals to access group scheduling functions and to download appointments made by a secretary from a company's computer system. Features such as a calculator and a voice recorder, are also common, and a wireless modem can be used with certain ISPs (Internet service providers) and email reader software to send and receive wireless emails.

Due to the PDA's remarkable usefulness, many PDA users believe that their PDA is indispensable and irreplaceable. The “contacts” function of PDAs have replaced paper telephone directories for many users. Given the phenomenal usefulness of the PDA, it may perhaps be surprising that PDAs are not used even more commonly than they are. Research on this question has shown that concern over the loss of a PDA is one important reason that dissuades consumers from buying PDAs.

Many users correctly realize that much of the data stored in a PDA may be difficult, if not impossible, to replace. Users often enter substantial amounts of information while on business trips (personal information of new contacts, for example) that has not yet been backed up onto a desktop computer; many users also need immediate access to information (directions to the next appointment, for example) while away from their offices. Backups of such data may not exist, or may be difficult or impossible to re-download, even if the user has been vigilant enough to synchronize recently with a desktop computer.

Many consumers also perceive a risk that data stored on a PDA (including financial information, passwords, or other personal information) can be misused if it falls into the “wrong hands.” A heavily-used PDA might contain large amounts of information about its owner's friends, family members, clients, customers, suppliers, including personal and business-related emails, personal unlisted telephone numbers, email addresses, and other contact information. These concerns have been mitigated, though not entirely eliminated, by password-protection, encryption, and even wiping software (that wipes a PDA of all data when an incorrect password is entered).

### SUMMARY OF THE INVENTION

The present invention is a simple, cost effective solution to reducing a chance that a user's PDA will become lost or misplaced. The preferred embodiment includes a mechanism to reduce those instances in which a PDA is misplaced, lost, stolen, or forgotten. The mechanism does not prevent users from deploying their PDA normally; if a user ordinarily carries a PDA in a shirt pocket or in a handbag. The mechanism is not of such size or weight as to prevent the user from continuing to carry the PDA in a shirt pocket or in a handbag. Also, since many current PDA users have already customized their PDAs (some to a very great degree), the mechanism preferably does not require a new PDA to be purchased. The mechanism preferably does not require embedding inside the PDA.

In a preferred embodiment, the apparatus includes a PDA protection system for alerting a user of a PDA that the PDA is more than a predetermined distance from the user. The apparatus includes a transmitting apparatus operative to provide a signal; a receiving apparatus operative to receive the signal, and to determine whether the PDA is more than the predetermined distance away from the user; and an indicator system, coupled to said receiving apparatus, for notifying the user that the PDA is more than the predetermined distance away from the user.

These and other novel aspects of the present invention will be apparent to those of ordinary skill in the art upon review of the drawings and the remaining portions of the specification.

### BRIEF DESCRIPTION OF THE DRAWINGS

FIG. 1 is a schematic diagram of a system in accordance with one embodiment of the present invention; and

FIG. 2 is a schematic diagram of a system in accordance with a second preferred embodiment of the present invention.

### DESCRIPTION OF THE SPECIFIC EMBODIMENTS

In a preferred embodiment, a PDA proximity device is designed to alert a PDA user, for example a Handspring Visor PDA owner, when they have moved beyond a predetermined distance from their PDA, such as when the PDA has been forgotten on a counter, for example. A transmitting apparatus physically coupled to the PDA, a tuned receiver carried with the user, and an indicating system cooperate to provide an indication to the user that the user has moved beyond the predetermined distance from the PDA. The transmitting apparatus includes a transmitter and a housing. The housing is configured, consistent with proper operation of the transmitter, to physically engage the PDA. Different PDAs will have different preferred mounting configurations. For example, in some cases, the PDA will have expansion capabilities for receiving expansion cards or adjunct equipment. The transmitter housing may be adapted to engage such expansion capabilities for the convenience of the user. In other applications, the transmitter housing may be configured to otherwise unobtrusively engage the PDA to physically couple the transmitter housing to the PDA.

Depending upon the application, the transmitter housing may be hard and/or rigid, or the transmitter housing may be flexible and conformable to the PDA. In some cases, the transmitter housing may be coupled via adhesive, releasable or relatively permanent. The transmitter has been described similar to a conventional transmitter in that it periodically issues a signal under its own control. In some applications, the transmitter may include a transponder function that responds to a query signal from a device carried/operated by the user. Similarly, the transmitting apparatus may be configured as a transceiver and either automatically, or in response to a user initiated query, activate a portion of the indicating system incorporated into the transceiver. In response to the user initiated query, an indication will be perceptible from the location of the PDA in addition to (or in lieu of) the indication at the receiving apparatus.

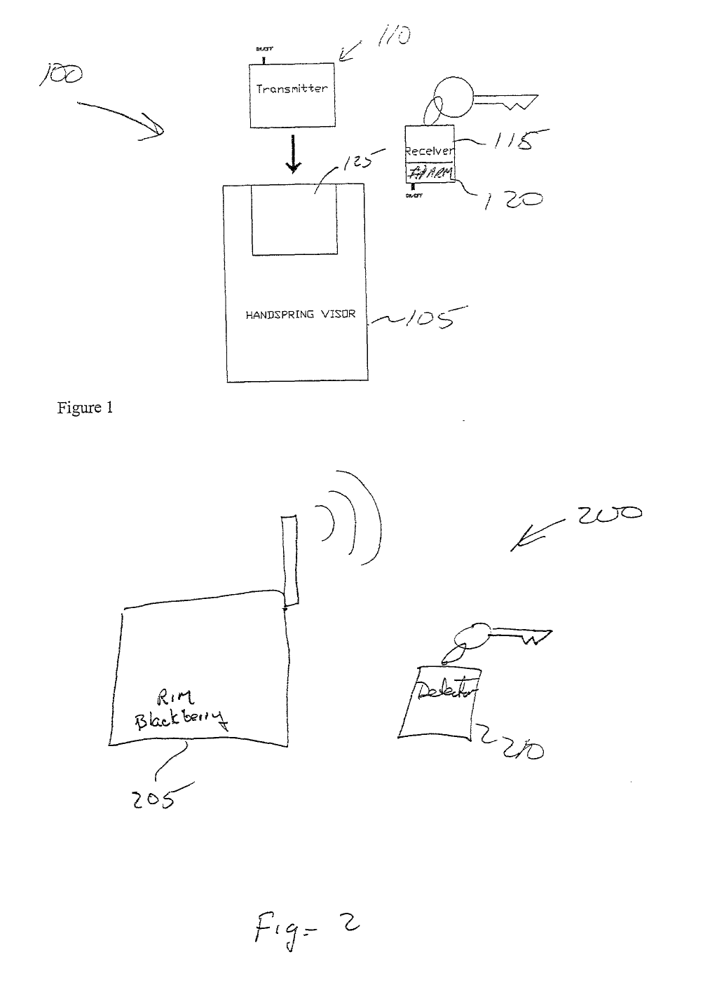

FIG. 1 is a schematic diagram of a PDA loss prevention system 100 in accordance with one embodiment of the present invention. System 100 alerts a user of a PDA 105 that the user has separated from PDA 105 by a predetermined distance. System 100 may also be configured to alert a user of PDA 105 that a battery unit of a component of system 100 is low on energy. System 100 includes a transmitting apparatus 110, a receiving apparatus 115 and an indicating system 120.

Transmitter 110 is an electronic device integrated into a housing. In certain preferred applications such as when PDA 105 includes a standard expansion slot 125, the housing may be configured to conform to mounting requirements of the expansion slot. When the housing conforms to mounting prerequisites of an expansion card, the housing may be inserted into, and housed within, expansion slot 125. In such a preferred embodiment, all electronics, PCB, batteries and plastics fit within expansion slot 125 just as an expansion card would do. Transmitter 110 need not communicate with PDA 105, simple physical coupling of transmitter 110 to PDA 105 is sufficient for most applications. Therefore, the present invention is not limited for use with PDAs, as other portable devices or implements (e.g., laptop computers, handbags, backpacks, luggage) may be protected as well. Transmitter 110 may optionally include an on/off switch. Further, transmitter 110 may be configured to send encoded signals which, in a preferred embodiment, would be a unique code or serial number to allow receiver 115 to discriminate on specific transmitters 110.

Receiver 115 is preferably coupled to a user's key ring or other device or structure frequently and easily carried by a user. Receiver 115 is tuned to transmitter 110, and in the preferred embodiment in which transmitter 110 issues a unique identifier, receiver 115 decodes transmitter signals and operates based upon one or more specific identifiers. Receiver 115 may be configured to be reactive to a range of unique identifiers, such as when the user employs several transmitters on various different equipment. Alternatively, each transmitter 110 of a set of transmitters protecting multiple pieces of equipment could be set to transmit the same identifier to receiver 115.

An indicating system 120, coupled to receiver 115, provides an indication to the user when receiver 115 detects that it has moved beyond a predetermined range from transmitter 110. There are many different types of indicating systems, such as an alarm that produces audible or visual cues, or both. Other indication systems may be employed, such a tactile or vibratory indications. Receiver 115 and/or indicating system 120 may be provided with an on/off switch. Alternatively, a reset switch may be used to reset system 100.

It may be desirable in some applications to provide transceivers for transmitter 110 and receiver 115. A user could activate a transceiver 115 (in lieu of receiver 115) and send a query signal to transceiver 110 (in lieu of transmitter 110) to have transceiver provide an indication (e.g. audible signal) as to the location of PDA 105.

In accordance with a preferred embodiment, PDA 105 is a Handspring Visor and transmitter 110 is specifically designed to be operable with it. Handspring Visors are a common type of PDA 105. If desired, other types of PDAs may be used. Similarly, in accordance with one embodiment of the present invention, the expansion slot is a Springboard expansion slot.

In accordance with the preferred embodiment of the present invention, transmitter 110 is operative to generate and transmit radio-frequency signals. The radio-frequency signals are, for example, encoded low power signals in the 900 MHz range. If desired, another frequency may be used, or higher power signals may be used. The encoded lower power signals may, for example, carry and repeat a code representing the serial number of the transmitting unit.

In accordance with one embodiment of the present invention, transmitter 110 is powered by a battery unit that contains non-rechargeable alkaline batteries. Although such batteries must be replaced occasionally, they are generally far less expensive than rechargeable nickel-cadmium batteries or other batteries that might be used. If desired, the non-rechargeable alkaline batteries may be replaced with one or more other types of batteries. In accordance with one embodiment of the present invention, the battery unit has sufficient energy to allow the transmitter unit to transmit signals for a sufficient period, which in the preferred embodiment may be about 400-500 hours. This amount of energy is selected to allow the transmitter unit to transmit eight hours per day for two months (approximately 60 days). Of course, more or less energy may be included within the battery unit.

Specifically, and as an example, the battery unit contains a small watch battery or two small watch batteries. Watch batteries are commonly available, and so busy travelers may purchase replacement batteries while on a trip. Such batteries are generally small and very light weight, and therefore extra batteries may also be carried conveniently by the PDA user.

While in a normal operating mode, indicating system 120 is operative to determine whether the battery unit has at least a threshold level of energy stored therein. The threshold level may be, for example, 5% of the energy that would be sufficient to allow transmitter 110 to transmit signals for a preferred period, of at least 480 hours for example. The 5% level would allow the user approximately three days to replace the battery or batteries within the battery unit. If desired, a different threshold level of energy may be set.

In response to a determination that the battery unit does not have at least the threshold level of energy stored therein, indicating system 120 generates a second alarm. The second alarm is observably different from the first alarm. For example, the alarm unit generates the second alarm by generating a periodic beeping sound.

Receiver 115 receives signals from transmitter 110, which is remote with respect to receiver 115. Receiver 115 is operative to receive radio-frequency (RF) signals from transmitter 110. In the embodiment where transmitter 110 issues encoded signals, because receiver 115 is matched to transmitter 110, and because the radio-frequency signals are encoded, receiver 115 is able to disregard any radio-frequency signals from any other transmitters associated with other PDAs that the user, or anyone else, might be using. For example, if the user misplaces PDA 105 and then moves away from the location of PDA 105 (carrying receiver 115) to another location close to where a second PDA (not shown) is being used, receiver 115 will discriminate the radio-frequency signals from the second PDA and will base activation of indicating system 120 on the radio-frequency signals from PDA 105.

In the preferred embodiment, receiver 115 includes a comparator that determines whether a distance between receiver 115 and transmitter 110 is greater than a predetermined threshold distance. In accordance with one embodiment of the present invention, the comparator relies upon a received power level of the radio-frequency signals issued from transmitter 110. A manufacturer determines an expected transmission power, and then determines a fraction of the expected transmission power using a radar range equation. The manufacturer then multiples the fraction by the expected transmission power to obtain the predetermined threshold power level that is programmed into the comparator. When the comparator determines that the receiver radio frequency signals have a power that is less than the predetermined threshold power level, the comparator determines that the distance between receiver 115 and transmitter 110 is greater than a predetermined threshold distance. Similarly, if desired, the comparator may determine a signal-to-noise ratio. When the signal-to-noise ratio falls below a predetermined threshold, then the comparator determines that the distance between receiver 115 and transmitter 110 is greater than a predetermined threshold distance.

In accordance with one embodiment of the present invention, the predetermined threshold distance is between 8 feet and 20 feet. Such a distance is great enough to avoid many false alarms as the user moves about. The distance is also great enough to allow the user to place the PDA in a briefcase or suitcase and receiver 115 in a shirt pocket without generating a false alarm. On the other hand, such a distance is sufficiently short that a user will not generally have strayed too far away. If the user is too far away from PDA 105, the user may not be able to return to 105 PDA to collect it after activation of indicating system 120.

Indicating system 120 also includes a flag. The flag is used to reset receiver 115. The user may manually set the flag, for example while replacing batteries in transmitter 110, to prevent indicating system 120 from generating the first alarm. If the user allows the flag to remain clear, then receiver 115 generates a first alarm and sets the flag in response the comparator's determination that transmitter 110 and receiver 115 are too far apart.

In accordance with a preferred embodiment, indicating system 120 generates the first alarm which is a periodic audible sound (e.g., beeping), including a beep every approximately 0.5 seconds. If desired, the beeping sound may be replaced with a vibration, or with a playing of a musical melody. If desired, the user may be permitted to change which musical melody is to be played, so that within a confined area such as an airport seating area, different users are alerted by different first alarms. Other types of first alarms may also be used.

Once indicating system 120 begins to generate the first alarm, first alarm continues until stopped. There are several events, any one or more of which will stop first alarm and clear the flag. For example, when receiver 115 and transmitter 110 move closer to each another, such that the distance between receiver 115 and transmitter 120 is no longer greater than the predetermined threshold distance, indicating system 120 will stop the first alarm and reset (clear) the flag. Also, when the user turns off receiver 115, then indicating system 120 will stop the first alarm and reset (clear) the flag. Further, when the user removes the battery (or inserts a new battery) into receiver 115, then indicating system 120 will stop the first alarm and reset (clear) the flag.

Receiver 115 also includes the on/off control. The on/off control is manually set or cleared by the user. Receiver 115 is operative to receive signals from the remote transmitter unit when the on/off control is on. By using the on/off control, the user may separate transmitter 110 from receiver 115 to a distance that exceeds the threshold distance, without generation of the first alarm.

In accordance with one embodiment of the present invention, receiver 115 is also powered by non-rechargeable alkaline batteries. The use of alkaline batteries in receiver 115 may be justified on the same basis as the use of alkaline batteries in transmitter 110.

In accordance with one embodiment of the present invention, receiver 115 and indicating system 120 is small enough to fit in a person's pocket, and is easily carried by the user when attached or integrated into the device ported by the user. For example, receiver 115 and indicating system 120 are mounted on a key chain.

FIG. 2 is a schematic diagram of a system 200 in accordance with a second preferred embodiment of the present invention. System 200 includes a specific type of PDA, specifically a PDA 205 having a built-in transmitter or transceiver. One well-known type of PDA 205 is a Blackberry PDA manufactured by RIM.

System 200 includes a detector 210 which incorporates a receiver or a transceiver. In operation, PDA 205 is configured to periodically transmit a signal. Detector 210 would be searching for this signal. Reception of the signal results in detector 210 remaining in an unalarmed status. Failure of detector 210 to receive the periodic signal triggers detector 210 to produce an alarm indication.

Alternatively, detector 210 may include a transceiver and transmit a query request to PDA 205. PDA 205, in response to the query request, would transmit a signal acknowledging receipt of the query request. Detector 210 would respond appropriately to detection of the acknowledgement signal and the strength of the acknowledgement signal.

It will be understood that the foregoing description is merely exemplary, and should not be interpreted as in any way limiting the scope of the invention, which is defined by the following claims and their equivalents:

What is claimed is:

1. A PDA protection system for alerting a user of a PDA that the PDA is more than a predetermined distance from the user, comprising:
a transmitting apparatus operative to provide a signal;
a receiving apparatus operative to receive the signal, and to determine whether the PDA is more than the predetermined distance away from the user; and
an indicator system, coupled to said receiving apparatus, for notifying the user that the PDA is more than the predetermined distance away from the user.

2. The PDA protection system of claim 1, wherein:
the transmitting apparatus has a housing adapted for insertion into, and housed within, an expansion slot of the PDA.

3. The PDA protection system of claim 1, wherein:
the apparatus is specifically designed to be interoperable with a Haindspring Visor.

4. The PDA protection system of claim 1, wherein:
expansion slot is a Springboard expansion slot.

5. The PDA protection system of claim 1, wherein:
the transmitter unit is operative to generate and transmit radio-frequency signals.

6. The PDA protection system of claim 1, wherein:
the transmitter unit is powered by a battery unit.

7. The PDA protection system of claim 6, wherein:
the battery unit contains non-rechargeable alkaline batteries.

8. The PDA protection system of claim 6, wherein:
the battery unit has sufficient power to allow the a transmitter unit to transmit signals for at least 480 hours.

9. The PDA protection system of claim 6, wherein:
the battery unit contains a small watch battery.

10. The PDA protection system of claim 6, wherein:
the battery unit contains two small watch batteries.

11. The PDA protection system of claim 6, wherein:
the alarm unit is operative to determine whether the battery unit has at least a threshold level of energy stored therein, and in response to a determination that the battery unit does not have at least the threshold level of energy stored therein, to generate a second alarm.

12. The PDA protection system of claim 9, wherein:
the first alarm is observably different from the second alarm.

13. The PDA protection system of claim 9, wherein:
the alarm unit is operative to generate the second alarm by generating a periodic beeping sound.

14. The PDA protection system of claim 1, wherein:
the receiving apparatus for alerting a user of a PDA that the PDA has been separated from the transmitter, the receiving apparatus comprising:
a receiver unit operative to receive signals from a remote transmitter unit;
a comparator operative to determine whether a distance between the receiver unit and the remote transmitter unit is greater than a predetermined threshold distance; and
an alarm unit operative to generate an first alarm and set a flag in response to the distance between the receiver unit and the remote transmitter unit becoming greater than a predetermined threshold distance while the flag is clear, the alarm unit being operative to clear the flag and stop the first alarm in response at least one off-turning event, the off-turning event being selected from a group consisting of: (1) the distance between the receiver unit and the remote transmitter unit being not greater than a predetermined threshold distance, (2) the receiver has been turned off, and (3) a new battery inserted being inserted into the receiver unit.

15. The receiving apparatus of claim 12, further comprising:
an on/off control, such that the receiver unit is only operative to receive signals from the remote transmitter unit when the on/off control is on.

16. The receiving apparatus of claim 12, wherein:
the alarm unit is operative to generate the first alarm by generating a a periodic beeping sound.

17. The receiving apparatus of claim 12, wherein:
the predetermined threshold distance is between 8 feet and 20 feet.

18. The receiving apparatus of claim 12, wherein:
the receiver is powered by non-rechargeable alkaline batteries.

19. The receiving apparatus of claim 12, wherein:
the receiving apparatus is small enough to fit in a person's pocket, and is carried by the user.

20. The receiving apparatus of claim 12, further comprising:
the receiving apparatus is mounted on a key chain.

21. The receiving apparatus of claim 12, further comprising:
the receiver unit operative to receive radio-frequency (RF) signals from the remote transmitter unit.

22. A mislocation inhibitor for a personal digital assistant (PDA) having a transmitter, comprising:
a portable detector having a receiver tuned for receipt of a periodic link signal transmitted from the transmitter;
a comparator, coupled to said portable detector, for asserting an alarm signal when said periodic link signal has not been received within a predetermined time window; and
an indicator, coupled to said comparator, for issuing an indication when said alarm signal is asserted.

23. A mislocation inhibiting system, comprising:
a personal digital assistant (PDA) having a transmitter that transmits a periodic link signal;
a portable detector having a receiver tuned for receipt of said periodic link signal;
a comparator, coupled to said portable detector, for asserting an alarm signal when said a received strength of said periodic link signal is less than a predetermined threshold due to said PDA and said detector physically separating; and
an indicator, coupled to said comparator, for issuing an indication when said alarm signal is asserted.

24. A mislocation inhibiting system, comprising:
a personal digital assistant (PDA) having a transceiver that transmits a link signal in response to a received issued query signal;
a transmitter for issuing a query signal;
a portable detector having a receiver tuned for receipt of said link signal;
a comparator, coupled to said portable detector, for asserting an alarm signal when said a received strength of said periodic link signal is less than a predetermined threshold due to said PDA and said detector physically separating; and
an indicator, coupled to said comparator, for issuing an indication when said alarm signal is asserted.
